(19) United States
(12) Patent Application Publication
(10) Pub. No.: US 2026/0316714 A1
(43) Pub. Date: Oct. 15, 2026

(54) SYSTEMS AND METHODS TO PREVENT VEHICLE OBJECT THEFT

(71) Applicant: Ford Global Technologies, LLC, Dearborn, MI (US)

(72) Inventors: Andrew Brady Brown, Royal Oak, MI (US); Brendan Diamond, Naples, FL (US); Keith Weston, Canton, MI (US); Ryan O'Gorman, Beverly Hills, MI (US)

(73) Assignee: Ford Global Technologies, LLC, Dearborn, MI (US)

(21) Appl. No.: 19/176,471

(22) Filed: Apr. 11, 2025

(51) Int. Cl. B60R 25/01; B60R 25/24; B60R 25/30; B60W 10/22; B60W 30/06

(52) U.S. Cl. CPC B60R 25/01; B60R 25/24; B60R 25/305; B60W 10/22; B60W 30/06; B60W 2552/15; B60W 2710/22

(57) ABSTRACT

A vehicle that prevents one or more vehicle components and/or cargo stored in the vehicle from getting stolen is disclosed. The vehicle may include a transceiver and a processor. The transceiver may receive a trigger signal. The processor may activate a predefined vehicle mode responsive to obtaining the trigger signal. The processor may further determine a vehicle component to be secured responsive to activating the predefined vehicle mode and determine an optimal vehicle orientation and/or an optimal vehicle location to secure the vehicle component. The processor may further perform a predefined action based on the optimal vehicle orientation and/or the optimal vehicle location to secure the vehicle component.

### FIELD

The present disclosure relates to vehicles and more specifically to a system and method to prevent theft of vehicle components or objects placed on a vehicle.

### BACKGROUND

Many users use their vehicles to store and transport cargo. In some cases, the cargo may be valuable, and the users may desire to secure the cargo on the vehicle so that it does not get stolen when the vehicle is left unattended. There are known cases of cargo stolen from cargo beds. Furthermore, it is known that vehicle components get stolen when the vehicle is left unattended. For example, there are known cases of stolen vehicle lights, wheels, tailgates, tail lamps, catalytic converters, and/or the like. Such instances of stolen cargo or vehicle components cause inconvenience to the users.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a view of an example vehicle in accordance with the present disclosure.

FIG. 2 depicts a block diagram of a system to prevent vehicle object theft in accordance with the present disclosure.

FIG. 3 depicts an example view of a vehicle parked on an inclined plane in accordance with the present disclosure.

FIG. 4 depicts an example view of a vehicle parked between two walls in accordance with the present disclosure.

FIG. 5 depicts an example view of a vehicle parked between two vehicles in accordance with the present disclosure.

FIG. 6 depicts an example view of a vehicle parked against a wall in accordance with the present disclosure.

FIG. 7 depicts a flow diagram of an example method to prevent vehicle object theft in accordance with the present disclosure.

### DETAILED DESCRIPTION

### Overview

The present disclosure describes a vehicle that facilitates a user in protecting or securing one or more vehicle components and/or cargo that may be stored on the vehicle's cargo bed. Specifically, the vehicle may prevent one or more vehicle components and/or the cargo from getting stolen when the vehicle may be parked or left unattended. Examples of such vehicle components include, but are not limited to, vehicle wheels, tailgate, cargo storage area, one or more tail lamps or vehicle lights, catalytic converters (not shown), and/or the like.

In some aspects, to prevent the vehicle component(s) (and/or the cargo) from getting stolen, the vehicle may first activate a vehicle's theft prevention mode when the vehicle is parked or about to be parked. In one exemplary aspect, the vehicle may activate the theft prevention mode based on user inputs obtained via a user device or a vehicle Human-Machine Interface/HMI (e.g., when the vehicle owner transmits a request to the vehicle to secure the vehicle component(s) and/or the cargo). In another exemplary aspect, the vehicle may activate the theft prevention mode based on inputs obtained from a vehicle's sensory system (e.g., when the sensory system detects that a valuable cargo may be stored on the cargo bed or when the vehicle may be located in a predefined geolocation prone to theft).

Responsive to activating the theft prevention mode, the vehicle may determine the vehicle components to be secured based on the user inputs and/or the inputs obtained from the vehicle's sensory system. The vehicle may then determine an optimal vehicle orientation and/or location to secure the vehicle component. As an example, the vehicle memory may pre-store a mapping of a plurality of vehicle components (to be secured) with a plurality of optimal vehicle orientations and/or locations. The vehicle may use this mapping to determine the optimal vehicle orientation and/or location based on the determined vehicle component(s) to be secured. Responsive to determining the optimal vehicle orientation and/or location, the vehicle may perform one or more predefined actions to prevent the vehicle component from getting stolen. Examples of such actions are described above.

In one exemplary aspect, the vehicle may output a notification on the HMI indicating the optimal vehicle orientation and/or location so that the user may accordingly park the vehicle and secure the vehicle component. In another exemplary aspect, the vehicle may autonomously park the vehicle between two walls or vehicles to prevent access to the vehicle's wheels or park the vehicle on an inclined surface and/or a soft or uneven surface, when the vehicle components to be secured are the wheels. In yet another exemplary aspect, the vehicle may autonomously park or back-up the vehicle against a wall or any other immovable object, when the vehicle component to be secured is the tailgate and/or the cargo stored on the cargo bed (which may be accessed via the tailgate). The vehicle may further autonomously lower the vehicle's adjustable suspension to secure the vehicle component (e.g., vehicle component on the underside of the vehicle).

The vehicle may perform one or more additional actions to secure the vehicle component and prevent it from getting stolen. For example, the vehicle may autonomously move and park itself at a different location if the location on which the vehicle 100 is initially parked gets vacant (or the vehicle gets isolated at the initial parking location). As another example, the vehicle may autonomously move or park itself at a different location if the vehicle's sensory system detects a suspicious activity in proximity to the vehicle at the initial parking location (e.g., someone unknown continually peering in the windows, a second vehicle continually circling the vehicle, etc.).

The present disclosure discloses a vehicle that may secure one or more vehicle components and/or cargo that may be stored on the vehicle's cargo bed. The vehicle prevents the vehicle components and/or the cargo from getting stolen, without using any external device or equipment. Further, the vehicle performs one or more autonomous actions to secure the vehicle components and/or the cargo, thereby minimizing human intervention. These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

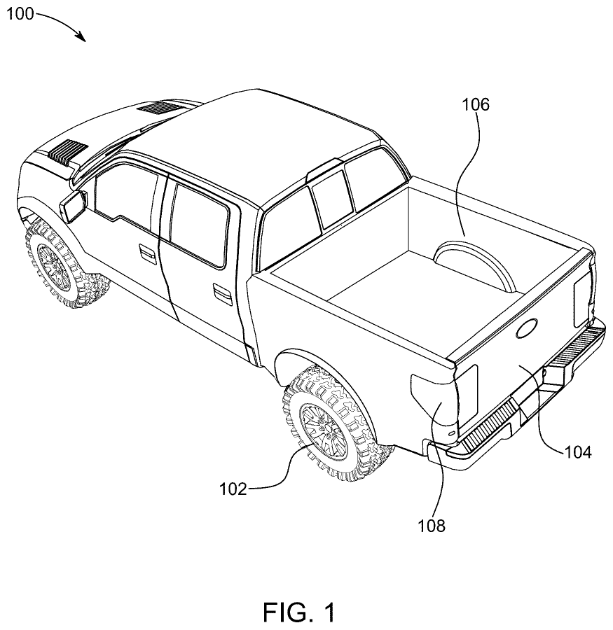

FIG. 1 depicts a view of an example vehicle 100 in accordance with the present disclosure. The vehicle 100 may take the form of any passenger or commercial vehicle such as a car, a work vehicle, a crossover vehicle, a truck, a van, a minivan, a taxi, a bus, etc. The vehicle 100 may be a manually driven vehicle or may be configured to operate in a partially/fully autonomous mode. Further, the vehicle 100 may include any powertrain, such as a gasoline engine, one or more electrically-actuated motor(s), or a hybrid system.

The vehicle 100 may include a plurality of vehicle components including, but not limited to, wheels 102, a tailgate 104, a cargo storage area 106 (or cargo area 106), one or more tail lamps or vehicle lights 108, catalytic converters (not shown), and/or the like. There are known instances of such vehicle components getting stolen, especially when the vehicle 100 is parked and left unattended. Furthermore, there are known instances of the cargo stored in the cargo area 106 getting stolen as well. Such instances may cause inconvenience to the vehicle owner. For example, if a vehicle component gets stolen, such component may be required to be reinstalled to restore the vehicle's operational condition. Further, many-a-times, the cargo that gets stolen may be valuable for the vehicle owner, and hence the owner may face economic inconvenience while re-purchasing the stolen cargo.

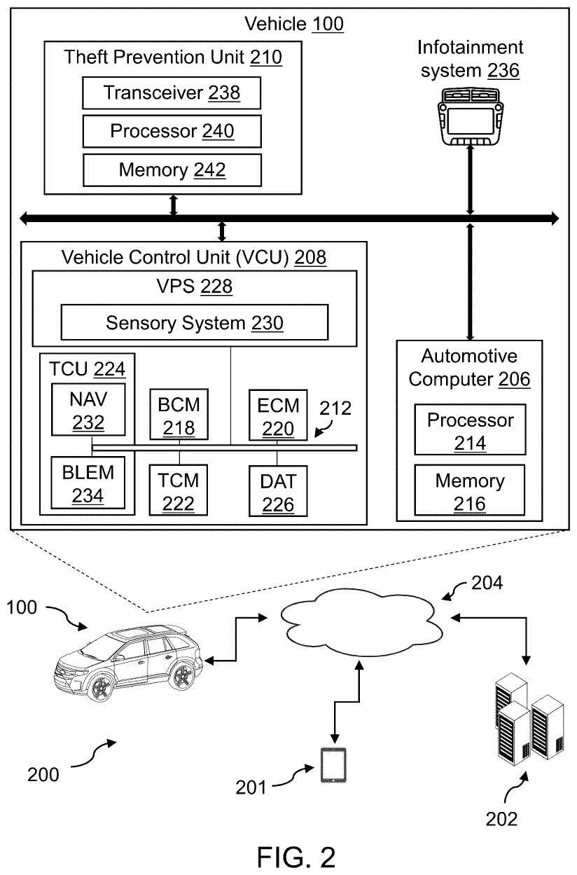

The vehicle 100, as disclosed in the present disclosure, facilitates the vehicle owner to secure the vehicle components and/or the cargo placed in the vehicle 100, when the owner desires to park and leave the vehicle 100 unattended. An example method implemented by the vehicle 100 to secure the vehicle components (and/or the cargo) is briefly described below and described in detail later below in conjunction with FIG. 2.

When the vehicle owner/user desires to park and leave the vehicle 100 unattended, the user may transmit (via a user device or a vehicle Human-Machine Interface (HMI)) user inputs to the vehicle 100 indicating that the user intends to secure the vehicle components (and/or the cargo). In some aspects, the user inputs may also indicate the specific vehicle components to be secured. For example, the user may indicate that the user desires to secure the wheels 102, the tailgate 104 (e.g., when the user desires to secure the tailgate 104 or the cargo placed in the cargo area 106 that may be accessed via the tailgate 104), the vehicle lights 108, and/or the like.

The user inputs described above may act as a “trigger signal” for the vehicle 100, which may activate a predefined vehicle mode (e.g., a vehicle theft prevention mode) responsive to receiving the trigger signal.

In alternative aspects, the vehicle 100 may automatically activate the vehicle's theft prevention mode when the vehicle 100 determines that the cargo area 106 may be storing valuable cargo. In this aspect, the vehicle 100 may determine that the cargo area 106 may be storing valuable cargo based on inputs obtained from a vehicle's sensory system (e.g., images captured by one or more vehicle cameras). In this case, the inputs obtained from the sensory system may act as the trigger signal described above, which the vehicle 100 may use to activate the vehicle's theft prevention mode. Furthermore, in this case, the vehicle 100 may determine that the vehicle component(s) that needs to be secured is the cargo area 106 and/or the tailgate 104, based on the inputs obtained from the sensory system that indicates that the cargo area 106 may be storing valuable cargo.

Responsive to activating the vehicle theft prevention mode (and determining the vehicle component to be secured), the vehicle 100 may determine an optimal vehicle orientation or an optimal vehicle location based on the vehicle component to be secured, which may prevent it from getting stolen. In some aspects, a vehicle memory (shown as memory 242 in FIG. 2) may store a mapping of a plurality of vehicle components (to be secured) with a plurality of optimal vehicle orientations and/or locations. For example, the memory may store a mapping that indicates that when the wheels 102 are to be secured, the optimal vehicle orientation is an inclined orientation. As another example, the memory may store a mapping that indicates that when the wheels 102 are to be secured, the optimal vehicle location is a location where the vehicle 100 is parked between two walls or two vehicles. As another example, the memory may store a mapping that indicates that when the cargo stored in the cargo area 106 is to be secured, the optimal vehicle location is a location where the vehicle 100 is parked against a wall such that the tailgate 104 is in proximity to the wall. The examples described herein should not be construed as limiting.

The vehicle 100 may use this mapping to determine the optimal vehicle orientation and/or location based on the determined vehicle component(s) to be secured. The vehicle 100 may then perform one or more predefined actions to secure the vehicle component (or the cargo placed in the vehicle 100), based on the determined optimal vehicle orientation and/or location. Example actions performed by the vehicle 100 to secure the vehicle component and prevent it from getting stolen are described below. The examples described below should not be construed as limiting the scope of the present disclosure.

In one exemplary aspect, the vehicle 100 may output a notification on the vehicle HMI and/or the user device indicating the optimal vehicle orientation and/or location. The user may view/hear the notification and accordingly park the vehicle 100 in the optimal vehicle orientation and/or location to secure the vehicle component.

In a second exemplary aspect, the vehicle 100 may autonomously identify and park the vehicle 100 on an inclined or a declined surface when the vehicle components to be secured are the wheels 102. It may be appreciated that it is difficult to jack up the vehicle 100 on an inclined or a declined surface, and hence a malicious user may find it challenging to steal the wheels 102 when the vehicle 100 is parked on such a surface. In this case, the vehicle 100 may determine (based on the mapping described above) that the optimal vehicle orientation is an inclined orientation when the vehicle components to be secured are the wheels 102, and hence the vehicle 100 may autonomously identify and park the vehicle 100 on an inclined surface to prevent the wheels 102 from getting stolen.

In a third exemplary aspect, the vehicle 100 may autonomously identify and park the vehicle 100 on a soft or an uneven surface (such as sand, silt, mud, rocks, etc.) when the vehicle components to be secured are the wheels 102. It may be appreciated that such a surface reduces the ergonomics and effectiveness of getting a floor jack under the vehicle 100 and reduces the stability of jack stands. Therefore, in this case, it may be difficult for a malicious user to install the jack under the vehicle 100, and hence the probability of the wheels 102 getting stolen is considerably reduced when the vehicle 100 is parked on such a surface. In this case, the vehicle 100 may determine (based on the mapping described above) the optimal vehicle location to be a location which has a soft or an uneven surface when the vehicle components to be secured are the wheels 102, and hence the vehicle 100 may autonomously identify and park the vehicle 100 on such a surface to prevent the wheels 102 from getting stolen.

In a fourth exemplary aspect, the vehicle 100 may autonomously identify and park the vehicle 100 between two walls (or close to one or more walls, or any other immovable surface) to reduce the physical access to the wheels 102 when the vehicle components to be secured are the wheels 102. It may be appreciated that if a malicious user cannot access the wheels 102 (due to the vehicle 100 being parked between two walls), the malicious user may find it difficult to steal them. In this case, the vehicle 100 may determine (based on the mapping described above) the optimal vehicle location to be a location in proximity to or between two walls when the vehicle components to be secured are the wheels 102, and hence the vehicle 100 may autonomously identify and park the vehicle 100 between two walls to prevent the wheels 102 from getting stolen.

In a similar manner, in a fifth exemplary aspect, the vehicle 100 may autonomously identify and park the vehicle 100 between two vehicles (or “second vehicles”) to reduce the physical access to the wheels 102 when the vehicle components to be secured are the wheels 102. In this case, the vehicle 100 may determine (based on the mapping described above) the optimal vehicle location to be a location in proximity to or between two second vehicles when the vehicle components to be secured are the wheels 102, and hence the vehicle 100 may autonomously identify and park the vehicle 100 between two second vehicles to prevent the wheels 102 from getting stolen.

In a sixth exemplary aspect, the vehicle 100 may autonomously identify and park the vehicle 100 against a wall (or any other immovable object) such that the tailgate 104 is close to the wall when the vehicle component to be secured is the tailgate 104 and/or the cargo area 106. It may appreciated that when the vehicle 100 is parked or backed-up against a wall, a malicious user may find it difficult to access the tailgate 104 and/or the cargo area 106, and hence the tailgate 104 and/or the cargo stored in the cargo area 106 may get protected from getting stolen. In this case, the vehicle 100 may determine (based on the mapping described above) the optimal vehicle location to be a location adjacent to a wall (or any other immovable object) when the vehicle components to be secured are the tailgate 104 and/or the cargo area 106, and hence the vehicle 100 may autonomously identify and park the vehicle 100 against a wall to prevent the tailgate 104 and/or the cargo located in the cargo area 106 from getting stolen.

In a seventh exemplary aspect, the vehicle 100 may autonomously lower the vehicle's adjustable suspension to secure the vehicle component (e.g., a component on the underside of the vehicle 100). It may be appreciated that lowering the vehicle's adjustable suspension reduces the ability for the malicious users to easily/inconspicuously access the underside of the vehicle 100, thereby securing the vehicle component.

The vehicle 100 may perform one or more additional actions to secure the vehicle component and prevent it from getting stolen. For example, the vehicle 100 may autonomously move and park itself in a different location if the location on which the vehicle 100 is initially parked gets vacant (or the vehicle 100 gets isolated at the initial parking location). As another example, the vehicle 100 may autonomously move or park itself at a different location if the vehicle's sensory system detects a suspicious activity in proximity to the vehicle 100 at the initial parking location (e.g., someone unknown continually peering in the windows, a second vehicle continually circling the vehicle 100, etc.). The vehicle 100 may further move and park itself at a different location (where there may be other vehicles around) if the surroundings at the initial parking location change substantially.

Further vehicle 100 details are described below in conjunction with FIG. 2.

The vehicle 100 implements and/or performs operations, as described here in the present disclosure, in accordance with the owner manual and safety guidelines. In addition, any action taken by the user based on the notifications provided by the vehicle 100 should comply with all the rules specific to the location and operation of the vehicle 100 (e.g., Federal, state, country, city, etc.). The notifications, as provided by the vehicle 100, should be treated as suggestions and only followed according to any rules specific to the location and operation of the vehicle 100.

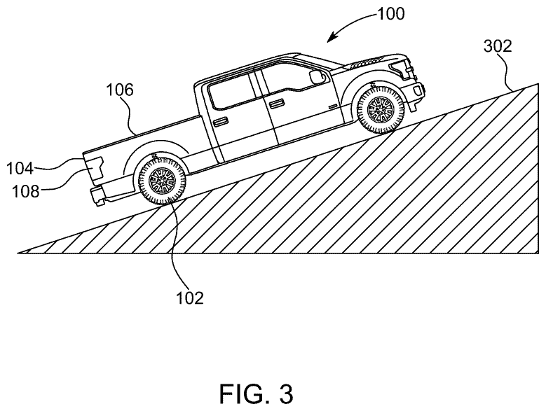

FIG. 2 depicts a block diagram of a system 200 to prevent vehicle object theft in accordance with the present disclosure. While describing FIG. 2, references will be made to FIGS. 3, 4, 5 and 6.

The system 200 may include the vehicle 100, a user device 201, and one or more servers 202 (or a server 202) that may be communicatively coupled with each other via one or more networks 204. The user device 201 may be associated with the vehicle owner/user and may be, for example, a mobile phone, a laptop, a computer, a tablet, a smartwatch, or any other similar device with communication capabilities. The server 202 may be part of a cloud-based computing infrastructure and may be associated with and/or include a Telematics Service Delivery Network (SDN) that provides digital data services to the vehicle 100 and other vehicles (not shown in FIG. 2) that may be part of a vehicle fleet.

The network(s) 204 illustrates an example communication infrastructure in which the connected devices discussed in various embodiments of this disclosure may communicate. The network(s) 204 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 100 may include a plurality of units including, but not limited to, an automotive computer 206, a Vehicle Control Unit (VCU) 208 and a theft prevention unit 210 (or unit 210). The VCU 208 may include a plurality of Electronic Control Units (ECUs) 212 in communication with the automotive computer 206.

In some aspects, the automotive computer 206 and/or the unit 210 may be installed anywhere in the vehicle 100, in accordance with the disclosure. Further, the automotive computer 206 may operate as a functional part of the unit 210. The automotive computer 206 may be or include an electronic vehicle controller, having one or more processor(s) 214 and a memory 216. Moreover, the unit 210 may be separate from the automotive computer 206 (as shown in FIG. 2) or may be integrated as part of the automotive computer 206.

The processor(s) 214 may be in communication with one or more memory devices in communication with the respective computing systems (e.g., the memory 216 and/or one or more external databases not shown in FIG. 2). The processor(s) 214 may utilize the memory 216 to store programs in code and/or to store data for performing aspects in accordance with the disclosure. The memory 216 may be a non-transitory computer-readable medium or memory storing a theft prevention program code. The memory 216 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 208 may share a power bus with the automotive computer 206 and may be configured and/or programmed to coordinate the data between vehicle 100 systems, connected servers (e.g., the server(s) 202), the user device 201 and other vehicles (not shown in FIG. 2) operating as part of a vehicle fleet. The VCU 208 may include or communicate with any combination of the ECUs 212, such as a Body Control Module (BCM) 218, an Engine Control Module (ECM) 220, a Transmission Control Module (TCM) 222, a Telematics Control Unit (TCU) 224, a Driver Assistances Technologies (DAT) controller 226, etc.

The VCU 208 may further include and/or communicate with a Vehicle Perception System (VPS) 228, having connectivity with and/or control of one or more vehicle sensory system(s) 230 (or a “sensor unit”). The vehicle sensory system 230 may include one or more vehicle sensors including, but not limited to, a radio detection and ranging (radar) sensor configured for detection and localization of objects inside and outside the vehicle 100 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle interior and exterior cameras, one or more rain sensors, a humidity sensor, a tire pressure sensor, ultrasonic sensors, one or more microphones, etc. The vehicle sensory system 230 may be configured to capture inputs associated with the vehicle 100 and the vehicle's surroundings.

In some aspects, the VCU 208 may control vehicle operational aspects and implement one or more instruction sets received from the user device 201, from one or more instruction sets stored in the memory 216, including operational instructions as part of the unit 210.

The TCU 224 may provide vehicle connectivity to wireless computing systems onboard and off board the vehicle 100 and may include a Navigation (NAV) receiver 232 for receiving and processing a GPS signal, a BLE Module (BLEM) 234, a Wi-Fi transceiver, a UWB transceiver, and/or other wireless transceivers (not shown in FIG. 2) that may be configurable for wireless communication (including cellular communication) between the vehicle 100 and other systems (e.g., the user device 201, a key fob, an NFC device, etc.), computers, and modules. The NAV receiver 232 may be configured to determine a real-time vehicle geolocation. The TCU 224 may be in communication with the ECUs 212 by way of a bus.

The ECUs 212 may control aspects of vehicle operation and communication using inputs from human drivers, inputs from an autonomous vehicle controller, the unit 210, and/or via wireless signal inputs received via the wireless connection(s) from other connected devices, such as the user device 201, the server(s) 202, among others.

The BCM 218 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, and/or the like. The BCM 218 may also operate as a gateway for bus and network interfaces to interact with remote ECUs (not shown in FIG. 2).

The DAT controller 226 may provide Level-1 through Level-3 automated driving and driver assistance functionality that may include, for example, active parking assistance, vehicle backup assistance, and adaptive cruise control, among other features. The DAT controller 226 may also provide aspects of user and environmental inputs usable for user authentication.

In some aspects, the automotive computer 206 may connect with an infotainment system 236 (or a vehicle Human-Machine Interface (HMI) 236). The infotainment system 236 may include a touchscreen interface portion and may include voice recognition features, biometric identification capabilities that can identify users based on facial recognition, voice recognition, fingerprint identification, or other biological identification means. In other aspects, the infotainment system 236 may further receive user instructions/inputs via the touchscreen interface portion and/or display notifications/recommendations, navigation maps, etc. on the touchscreen interface portion.

The computing system architecture of the automotive computer 206, the VCU 208, and/or the unit 210 may omit certain computing modules. It should be readily understood that the computing environment depicted in FIG. 2 is an example of a possible implementation according to the present disclosure, and thus, it should not be considered limiting or exclusive.

In accordance with some aspects, the unit 210 may be integrated with and/or executed as part of the ECUs 212. The unit 210, regardless of whether it is integrated with the automotive computer 206 or the ECUs 212, or whether it operates as an independent computing system in the vehicle 100, may include a transceiver 238, a processor 240, and a computer-readable memory 242.

The transceiver 238 may receive information/inputs from one or more external devices or systems, e.g., the user device 201, the server(s) 202, and/or the like via the network 204. For example, the transceiver 238 may receive the user inputs described above in conjunction with FIG. 1 from the user via the user device 201. As described above, the user may provide the user inputs to the vehicle 100 when the user desires the vehicle 100 to activate the vehicle's theft prevention mode. Further, the user inputs may indicate the vehicle component(s) (and/or the cargo) that the user desires to secure and prevent from getting stolen.

The transceiver 238 may further transmit notifications/data/signals to the external devices or systems. In addition, the transceiver 238 may receive information/inputs from vehicle 100 components such as the infotainment system 236, the VCU 208 (e.g., the vehicle sensory system 230), and/or the like. Further, the transceiver 238 may transmit notifications/command signals to the vehicle 100 components such as the VCU 208, the infotainment system 236, the BCM 218, etc.

The processor 240 and the memory 242 may be the same as or similar to the processor 214 and the memory 216, respectively. In some aspects, the processor 240 may utilize the memory 242 to store programs in code and/or to store data for performing aspects in accordance with the disclosure. The memory 242 may be a non-transitory computer-readable medium or memory storing the theft prevention program code. As described above in conjunction with FIG. 1, the memory 242 may store the mapping of a plurality of vehicle components (to be secured) with a plurality of optimal vehicle orientations and/or locations.

In operation, the transceiver 238 may first receive a trigger signal when the vehicle's theft prevention mode is to be activated. In some aspects, the transceiver 238 may receive the trigger signal when the user provides the user inputs to the vehicle 100 via the user device 201 or the HMI 236. In other aspects, as described above in conjunction with FIG. 1, the transceiver 238 may receive the trigger signal from the vehicle sensory system 230 when the vehicle sensory system 230 determines (e.g., via the images captured by the vehicle cameras) that the cargo area 106 may be storing valuable cargo. In yet another aspect, the transceiver 238 may receive the trigger signal from the server 202, when the server 202 determines that the vehicle 100 may be located in a predefined geographical area that may be prone to vehicle component theft (which may be identified, e.g., based on historical data).

The transceiver 238 may transmit the trigger signal to the processor 240. The processor 240 may activate the vehicle's theft prevention mode responsive to obtaining the trigger signal. The processor 240 may then determine the vehicle component(s) to be secured based on the user inputs and/or the inputs obtained from the vehicle sensory system 230, as described above in conjunction with FIG. 1. The processor 240 may further determine the optimal vehicle orientation and/or the optimal vehicle location to secure the determined vehicle component(s). As described above in conjunction with FIG. 1, the processor 240 may correlate the mapping stored in the memory 242 with the determined vehicle component(s) to be secured to determine the optimal vehicle orientation and/or the optimal vehicle location.

The processor 240 may then perform one or more predefined actions based on the optimal vehicle orientation or the optimal vehicle location, to secure the vehicle component. Examples of the actions performed by the processor 240 are described below and illustrated in FIGS. 3-6.

In one exemplary aspect, the processor 240 may output a notification on the HMI 236 and/or the user device 201 indicating the optimal vehicle orientation and/or location, as described above in conjunction with FIG. 1. The user may view/hear the notification and accordingly park the vehicle 100 in the optimal vehicle orientation and/or location to secure the vehicle component.

In a second exemplary aspect, the processor 240 may autonomously identify and park the vehicle 100 on an inclined surface 302 (or a declined surface) when the vehicle components to be secured are the wheels 102, as shown in FIG. 3. It may be appreciated that when the vehicle 100 is parked on the inclined surface 302, a malicious user may find it challenging to jack up the vehicle 100 and remove the wheels 102. In this manner, by autonomously parking the vehicle 100 on the inclined surface 302, the processor 240 prevents the wheels 102 from getting stolen.

In a third exemplary aspect, as described above in conjunction with FIG. 1, the processor 240 may autonomously identify and park the vehicle 100 on a soft or an uneven surface (such as sand, silt, mud, rocks, etc.) when the vehicle components to be secured are the wheels 102. It may be appreciated that a malicious user may find it challenging to install the jack under the vehicle 100 when the vehicle 100 is parked on such a surface. In this manner, by autonomously parking the vehicle 100 on a soft or uneven surface, the processor 240 prevents the malicious user from removing the wheels 102 and hence prevents the wheels 102 from getting stolen.

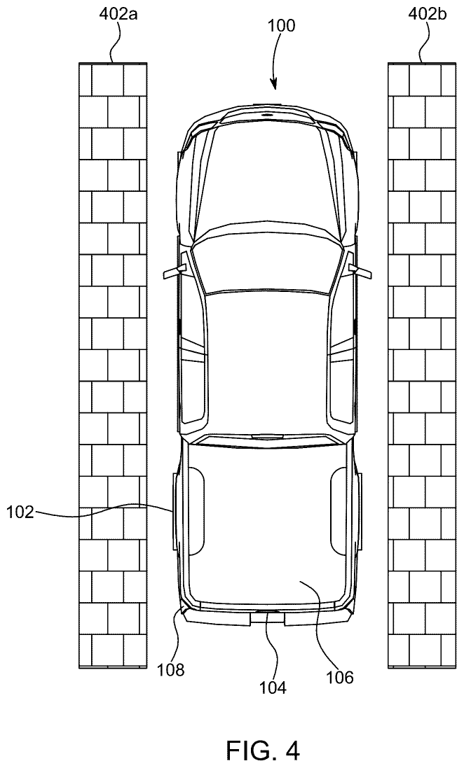

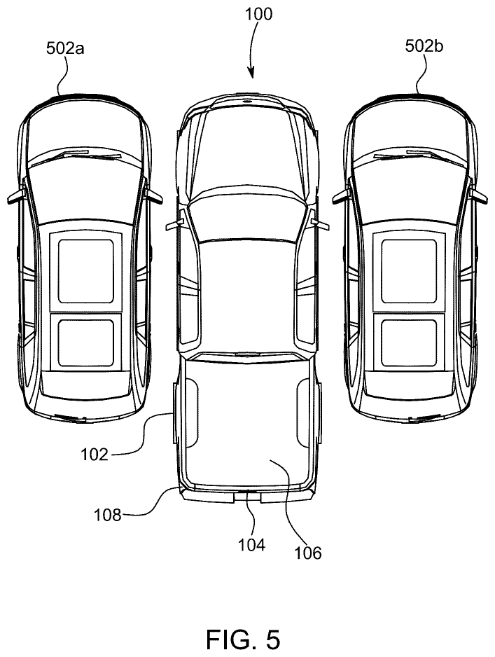

In a fourth exemplary aspect, the processor 240 may autonomously identify and park the vehicle 100 between two walls 402a, 402b (or in proximity to one or more walls, or any other immovable object) to reduce the physical access to the wheels 102, when the vehicle components to be secured are the wheels 102, as shown in FIG. 4. As described above, if a malicious user cannot access the wheels 102 (due to the vehicle 100 being parked between the two walls 402a, 402b), the malicious user may find it difficult to steal them. In a similar manner, in a fifth exemplary aspect, the processor 240 may autonomously identify and park the vehicle 100 between or in proximity to two vehicles 502a, 502b (or two “second vehicles” 502a, 502b) to reduce the physical access to the wheels 102, when the vehicle components to be secured are the wheels 102, as shown in FIG. 5.

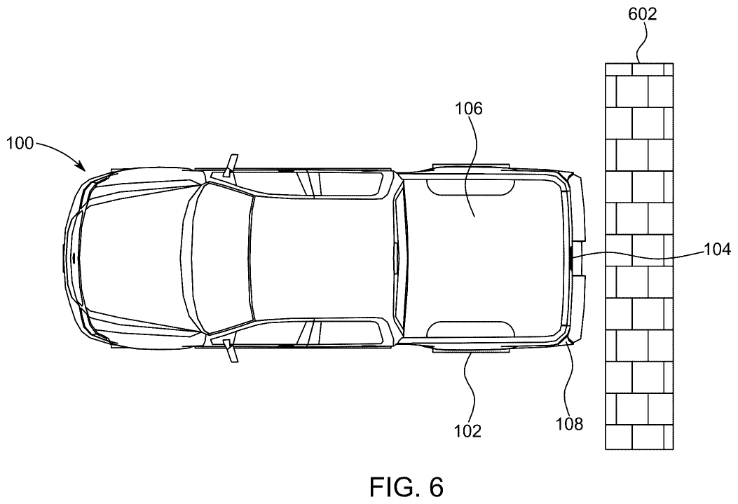

In a sixth exemplary aspect, the processor 240 may autonomously identify and park the vehicle 100 against a wall 602 (or any other immovable surface/object) such that the tailgate 104 is close to the wall 602 when the vehicle component to be secured is the tailgate 104 and/or the cargo area 106, as shown in FIG. 6. As described above, when the vehicle 100 is parked or backed-up against the wall 602, a malicious user may find it difficult to access the tailgate 104 and/or the cargo area 106, and hence the tailgate 104 and/or the cargo stored in the cargo area 106 may get protected from getting stolen.

In further aspects, the processor 240 may perform one or more additional actions to prevent the vehicle component(s) and/or the cargo stored in the vehicle 100 from getting stolen. For example, the processor 240 may autonomously lower the vehicle's adjustable suspension to secure the vehicle component. As described above, lowering the vehicle's adjustable suspension reduces the ability for the malicious users to easily/inconspicuously access the underside of the vehicle 100, thereby securing the vehicle component.

The processor 240 may further continuously monitor the inputs captured by the vehicle sensory system 230 (e.g., images captured by the vehicle cameras) to check if the vehicle 100 is becoming isolated in the current parking location (or a “first parking location”) where the vehicle 100 may be parked. Responsive to determining that the vehicle 100 may have become isolated at the current parking location (e.g., if all the other vehicles may have left the parking location), the processor 240 may autonomously move the vehicle 100 to a different parking location (or a “second parking location”) where the vehicle 100 may not be isolated, to secure the vehicle component.

In additional aspects, the processor 240 may continuously monitor the inputs captured by the vehicle sensory system 230 (e.g., images captured by the vehicle cameras) to check if any suspicious activity is occurring in proximity to the vehicle 100 at the current parking location. In some aspects, the memory 242 may store information associated with a plurality of typical suspicious activities/events, and the processor 240 may correlate the inputs (images or audio signals) captured by the vehicle sensory system 230 with this stored information to determine that a suspicious activity may be occurring in proximity to the vehicle 100. The processor 240 may additionally use Machine Learning (ML) or Artificial Intelligence (AI) to determine that a suspicious activity may be occurring in proximity to the vehicle 100 based on the captured images/audio signals. Responsive to determining that a predefined suspicious activity may be occurring in proximity to the vehicle 100 at the current parking location (e.g., someone unknown continually peering in the windows, a second vehicle continually circling the vehicle 100, etc.), the processor 240 may autonomously move the vehicle 100 to a different parking location (or the second parking location) to secure the vehicle component. The processor 240 may further move and park the vehicle 100 to a different location (where there may be other vehicles around) if the surroundings at the initial parking location change substantially (determined based on the inputs captured by the vehicle sensory system 230).

By implementing one or more methods described above, the processor 240 facilitates the vehicle owner in protecting/securing the vehicle component(s) and/or the cargo stored in the vehicle 100.

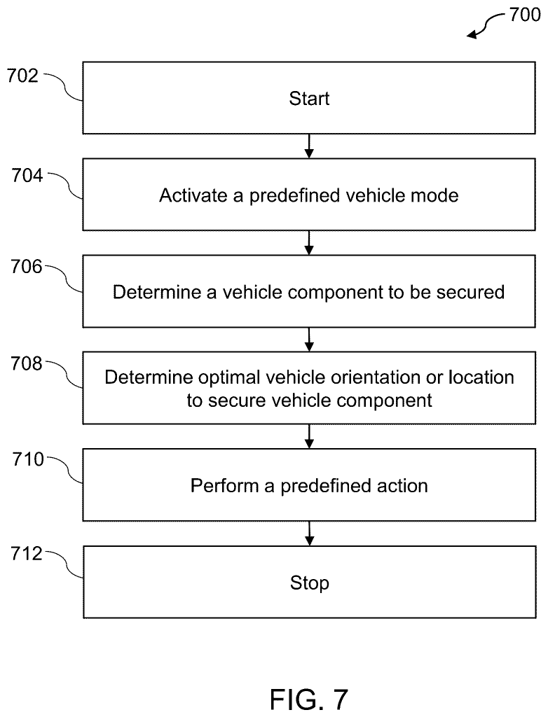

FIG. 7 depicts a flow diagram of an example method 700 to prevent vehicle object theft in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include activating, by the processor 240, the vehicle's theft prevention mode responsive to obtaining the trigger signal, as described above. At step 706, the method 700 may include determining, by the processor 240, the vehicle component(s) to be secured responsive to activating the theft prevention mode. At step 708, the method 700 may include determining, by the processor 240, the optimal vehicle orientation and/or location to secure the vehicle component. At step 710, the method 700 may include performing, by the processor 240, one or more predefined actions based on the optimal vehicle orientation and/or the optimal vehicle location to secure the vehicle component, as described above in conjunction with FIG. 2.

At step 712, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a transceiver configured to receive a trigger signal; and
a processor configured to:
activate a predefined vehicle mode responsive to obtaining the trigger signal;
determine a vehicle component to be secured responsive to activating the predefined vehicle mode;
determine an optimal vehicle orientation or an optimal vehicle location to secure the vehicle component; and
perform a predefined action based on the optimal vehicle orientation or the optimal vehicle location to secure the vehicle component,
wherein the optimal vehicle orientation is an inclined orientation when the vehicle component is vehicle wheels, and wherein, to perform the predefined action, the processor autonomously parks the vehicle on an inclined surface or a declined surface when the vehicle component is the vehicle wheels.

2. The vehicle of claim 1, wherein the transceiver receives the trigger signal via user inputs.

3. The vehicle of claim 2, wherein the processor determines the vehicle component to be secured based on the user inputs.

4. The vehicle of claim 1 further comprising a sensory system configured to capture inputs associated with the vehicle and vehicle's surroundings, wherein the transceiver receives the trigger signal from the sensory system.

5. The vehicle of claim 4, wherein the processor determines the vehicle component to be secured based on the inputs obtained from the sensory system.

6. The vehicle of claim 4, wherein the sensory system comprises one or more of: a vehicle camera, a Radio Detection and Ranging (radar) sensor, or a Light Detection and Ranging (lidar) sensor.

7. The vehicle of claim 1 further comprising a Human-Machine Interface (HMI), wherein, to perform the predefined action, the processor outputs a notification indicating the optimal vehicle orientation or the optimal vehicle location on the HMI.

8. (canceled)

9. The vehicle of claim 1, wherein the optimal vehicle location is a location having an uneven surface or a soft surface when the vehicle component is vehicle wheels, and wherein, to perform the predefined action, the processor autonomously parks the vehicle on the uneven surface or the soft surface when the vehicle component is the vehicle wheels.

10. The vehicle of claim 1, wherein the optimal vehicle location is a location in proximity to one or more walls when the vehicle component is vehicle wheels, a vehicle tailgate or a vehicle cargo area, and wherein, to perform the predefined action, the processor autonomously parks the vehicle in proximity to the one or more walls when the vehicle component is the vehicle wheels, the vehicle tailgate or the vehicle cargo area.

11. The vehicle of claim 1, wherein the optimal vehicle location is a location in proximity to one or more second vehicles when the vehicle component is vehicle wheels, and wherein, to perform the predefined action, the processor autonomously parks the vehicle in proximity to the one or more second vehicles when the vehicle component is the vehicle wheels.

12. The vehicle of claim 4, wherein the processor is further configured to:
determine that the vehicle is isolated in a first parking location where the vehicle is parked based on the inputs obtained from the sensory system; and
autonomously move the vehicle to a second parking location to secure the vehicle component, responsive to determining that the vehicle is isolated in the first parking location.

13. The vehicle of claim 4, wherein the processor is further configured to:
identify a predefined suspicious activity in proximity to the vehicle at a first parking location where the vehicle is parked based on the inputs obtained from the sensory system; and
autonomously move the vehicle to a second parking location to secure the vehicle component, responsive to identifying the predefined suspicious activity in proximity to the vehicle.

14. The vehicle of claim 1, wherein the processor is further configured to autonomously lower a vehicle's adjustable suspension to secure the vehicle component.

15-20. (canceled)

21. A vehicle comprising:
a transceiver configured to receive a trigger signal; and
a processor configured to:
activate a predefined vehicle mode responsive to obtaining the trigger signal;
determine a vehicle component to be secured responsive to activating the predefined vehicle mode;
determine an optimal vehicle orientation or an optimal vehicle location to secure the vehicle component; and
perform a predefined action based on the optimal vehicle orientation or the optimal vehicle location to secure the vehicle component,
wherein the optimal vehicle location is a location having an uneven surface or a soft surface when the vehicle component is vehicle wheels, and wherein, to perform the predefined action, the processor autonomously parks the vehicle on the uneven surface or the soft surface when the vehicle component is the vehicle wheels.

22. A vehicle comprising:
a transceiver configured to receive a trigger signal; and
a processor configured to:
activate a predefined vehicle mode responsive to obtaining the trigger signal;
determine a vehicle component to be secured responsive to activating the predefined vehicle mode;
determine an optimal vehicle orientation or an optimal vehicle location to secure the vehicle component; and
perform a predefined action based on the optimal vehicle orientation or the optimal vehicle location to secure the vehicle component,
wherein the optimal vehicle location is a location in proximity to one or more second vehicles when the vehicle component is vehicle wheels, and wherein, to perform the predefined action, the processor autonomously parks the vehicle in proximity to the one or more second vehicles when the vehicle component is the vehicle wheels.

23. The vehicle of claim 22, wherein the processor is further configured to:
determine that the vehicle is isolated in a first parking location where the vehicle is parked based on the inputs obtained from the sensory system; and
autonomously move the vehicle to a second parking location to secure the vehicle component, responsive to determining that the vehicle is isolated in the first parking location.
